(19) United States
(12) Patent Application Publication
(10) Pub. No.: US 2026/0362366 A1
(43) Pub. Date: Nov. 12, 2026

(54) WIRELESS COMMUNICATION SYSTEM, LOCATION ESTIMATION METHOD AND WIRELESS COMMUNICATION APPARATUS

(71) Applicant: NTT, Inc., Tokyo (JP)

(72) Inventors: Tatsuhiko Iwakuni, Musashino-shi, Tokyo (JP); Daisei Uchida, Musashino-shi, Tokyo (JP); Takuto Arai, Musashino-shi, Tokyo (JP); Shuki WAI, Musashino-shi, Tokyo (JP); Naoki Kita, Musashino-shi, Tokyo (JP)

(21) Appl. No.: 18/997,588

(22) PCT Filed: Jul. 26, 2022
(86) PCT No.: PCT/JP2022/028736

§ 371 Date: Jan. 22, 2025

(51) Int. Cl. H04W 64/00; H04B 7/06; H04B 17/318

(52) U.S. Cl. CPC H04W 64/00; H04B 7/0617; H04B 17/328

(57) ABSTRACT

A wireless communication system including a first communication device and one or more second communication devices that communicate with the first communication device, in which the first communication device includes a radio unit that forms a plurality of candidate beams in different directions and transmits a signal for each of the candidate beams, and receives a response to a signal received by the one or more second communication devices, a radio control unit that acquires quality information regarding the candidate beams for each of the candidate beams on the basis of the response received by the radio unit, and a position estimation unit that refers to correspondence information in which the quality information of each of the candidate beams and position information are associated with each other, and estimates a position of the one or more second communication devices on the basis of the quality information of each of the candidate beams acquired by the radio control unit, and the one or more second communication devices transmit a response to a signal transmitted from the first communication device.

### TECHNICAL FIELD

The present invention relates to a wireless communication system, a position estimation method, and a wireless communication device.

### BACKGROUND ART

Wireless communication using millimeter waves or quasi-millimeter waves classified into a high frequency band includes 3rd Generation Partnership Project (3GPP) (registered trademark) 5th Generation (5G) New Radio (NR), IEEE 802.11ad, and the like. These kinds of wireless communication have advantages such as being able to secure a wide band as compared with a microwave band in the related art and having large rectilinearity and less interference with other communication. Thus, practical use has been promoted as means for achieving large-capacity wireless communication (for example, Non Patent Literature 1).

A distance attenuation amount of a radio propagation path increases as the frequency increases. Thus, in communication in a millimeter wave band, in particular, in a wireless communication device, a directional beam is generally formed (beamforming) toward a wireless communication device that is a communication partner to transmit a signal. In addition, in a wireless communication device, it is also common to form a directional beam to receive a signal.

FIG. 7 is a diagram illustrating an example of a wireless communication system using beamforming in a general millimeter wave band. The wireless communication system illustrated in FIG. 7 includes a wireless communication device 50 and a wireless communication device 60. The wireless communication device 50 selects a beam having the maximum reception power in the opposing wireless communication device 60 from directional beams B1 to B9 (hereinafter referred to as a “candidate beam”) that can be formed by the wireless communication device 50. For example, in IEEE 802.11ad, beam selection is performed by procedure called a sector level sweep (SLS) (see, for example, Non Patent Literature 2).

The SLS described in Non Patent Literature 2 will be described. First, a wireless communication device (initiator) on a communication starting side sequentially transmits signals using possible beams in a time division manner. At this time, the wireless communication device (responder) on the opposite side receives a signal transmitted from the initiator with a beam having a maximum beam width, and measures reception power thereof. The responder may also sequentially transmit signals using the beam. For beam selection of the initiator, the beam selection is completed by sharing an ID of the beam for which the maximum reception power is obtained in the responder with the initiator.

Similarly, in the 5G NR, a plurality of signal blocks called synchronization signal/physical broadcast channel (SS/PBCH) are sequentially transmitted in a time division manner for each beam of the wireless communication device. The opposing wireless communication device reads this and feeds back information of the beam having the maximum reception power to the wireless communication device, whereby the initial beam selection is completed.

In the high frequency band, in addition to the magnitude of distance attenuation, when a blocking object enters a propagation path between antennas of the wireless communication device between transmission and reception, a propagation loss rapidly increases, and transmission of a signal becomes difficult. For this reason, in general, it is assumed that communication in the high frequency band is transmission in a line-of-sight environment in which no blocking object exists between antennas of wireless communication devices that perform communication. In such a case, the direction of the beam used by the wireless communication device directly indicates the direction of the opposing wireless communication device. In addition, for example, in the case of a wireless communication device having a distance estimation function using a round trip time (RTT) of a signal as disclosed in Non Patent Literature 3, it is possible to estimate the position of another wireless communication device using a signal itself transmitted from a certain wireless communication device.

Among the wireless communication devices, if the position of a terminal station device can be grasped, achievement of advanced communication control based on the position can be expected. For example, as described in Non Patent Literature 4, by performing base station switching based on the position of the wireless communication device, it is possible to stably switch the base station without being affected by instantaneous power fluctuation. The position of the wireless communication device is generally measured by a global navigation satellite system (GNSS) such as a global positioning system (GPS) or a global navigation satellite system (GLONASS) when outdoors, and is generally measured by a method such as Bluetooth (registered trademark) low energy (BLE) or ultra-wide band (UWB) when indoors. However, in these positioning methods, the wireless communication device needs to include a positioning unit such as a dedicated antenna or a positioning wireless receiving device. In order to estimate the position of the wireless communication device that does not include the positioning unit, terminal positioning based on a communication signal itself is required.

### CITATION LIST

### Non Patent Literature

Non Patent Literature 1: Takinami et al., “Standardization trend and elemental technology of millimeter wave band wireless LAN system”, The Institute of Electronics, Information and Communication Engineers, Communication Society Magazine, autumn 2016, No. 38, p. 100-106
Non Patent Literature 2: IEEE, “Part 11: Wireless LAN Medium Access Control (MAC) and Physical Layer (PHY) Specifications Amendment 3: Enhancements for Very High Throughput in the 60 GHz Band” (IEEE Std 802.11ad-2012), 2012 Dec. 28
Non Patent Literature 3: Iwakuni et al., “Koshuhasutai musen tsushin system ni okeru sokkyo kino o mochiita handover seigyo no tameno jikken hyoka (in Japanese) (Experimental Evaluation for Handover Control Using Distance Measuring Function in High Frequency Band Wireless Communication System)”, B-5-56, 2020 The Institute of Electronics, Information and Communication Engineers Society Conference
Non Patent Literature 4: T. Iwakuni, D. Uchida, S. Wai and N. Kita, “Millimeter-Wave Handover Experiment in 293 km/h Mobility Environment using Position Estimated from Wireless Communication Signal”, 2021 IEEE 94th Vehicular Technology Conference (VTC 2021-Fall), 2021, pp. 1-5, doi: 10.1109/VTC 2021-Fall52928.2021.9625347.

### SUMMARY OF INVENTION

### Technical Problem

The terminal positioning by the communication signal itself has one problem. That is, in a situation where wireless communication devices that perform communication are close to each other but a direct line-of-sight path is blocked, a signal is transmitted, in some cases, by being reflected by a surrounding object or the like. FIG. 8 is a diagram for describing a problem of the terminal positioning by the communication signal itself. FIG. 8 illustrates a situation in which an object 71 exists in the direct line-of-sight path between the wireless communication device 50 and the wireless communication device 60 and an object 72 exists in the direction of the beam B9 used by the wireless communication device 50.

Under such circumstances, the wireless communication device 50 does not necessarily exist in the direction of the beam used by the wireless communication device 60. For example, if the beam B9 is reflected by the object 72 existing in the direction of the beam B9 used by the wireless communication device 50 and reaches the wireless communication device 60, the wireless communication device 50 may determine that the wireless communication device 60 exists in the direction of the beam B9. Thus, the terminal positioning by the communication signal itself cannot accurately measure the position of the wireless communication device in some cases.

In view of the above circumstances, an object of the present invention is to provide a technology capable of more accurately estimating a position of a wireless communication device by using a signal used for communication.

### Solution to Problem

An aspect of the present invention is a wireless communication system including a first communication device and one or more second communication devices that communicate with the first communication device, in which the first communication device includes a radio unit that forms a plurality of candidate beams in different directions and transmits a signal for each of the candidate beams, and receives a response to a signal received by the one or more second communication devices, a radio control unit that acquires quality information regarding the candidate beams for each of the candidate beams on the basis of the response received by the radio unit, and a position estimation unit that refers to correspondence information in which the quality information of each of the candidate beams and position information are associated with each other, and estimates a position of the one or more second communication devices on the basis of the quality information of each of the candidate beams acquired by the radio control unit, and the one or more second communication devices transmit a response to a signal transmitted from the first communication device.

An aspect of the present invention is a position estimation method performed by a wireless communication system including a first communication device and one or more second communication devices that communicate with the first communication device, the position estimation method including, by the first communication device, forming a plurality of candidate beams in different directions and transmitting a signal for each of the candidate beams, receiving a response to a signal received by the one or more second communication devices, acquiring quality information regarding the candidate beams for each of the candidate beams on the basis of the received response, and referring to correspondence information in which the quality information of each of the candidate beams and position information are associated with each other, and estimating a position of the one or more second communication devices on the basis of the quality information of each of the acquired candidate beams, and by the one or more second communication devices, transmitting a response to a signal transmitted from the first communication device.

An aspect of the present invention is a wireless communication device including a radio unit that forms a plurality of candidate beams in different directions and transmits a signal for each of the candidate beams, and receives quality information regarding the candidate beams obtained for each of signals received by an opposing device for each of the candidate beams from the opposing device, and a position estimation unit that refers to correspondence information in which the quality information of each of the candidate beams and position information are associated with each other, and estimates position information of the opposing device on the basis of the quality information of each of the candidate beams acquired by the radio unit.

### Advantageous Effects of Invention

According to the present invention, it is possible to more accurately estimate the position of the wireless communication device by using a signal used for communication.

### BRIEF DESCRIPTION OF DRAWINGS

FIG. 1 A diagram illustrating a configuration example of a wireless communication system in an embodiment.

FIG. 2 A diagram illustrating a functional configuration example of a base station in the embodiment.

FIG. 3 A diagram illustrating an example of a quality information table in the embodiment.

FIG. 4 A diagram illustrating a configuration example of a wireless communication terminal (without a positioning function) in the embodiment.

FIG. 5 A diagram illustrating a configuration example of a wireless communication terminal (with a positioning function) in the embodiment.

FIG. 6 A flowchart illustrating a flow of position estimation processing performed by a base station in the embodiment.

FIG. 7 A diagram illustrating an example of a wireless communication system using beamforming in a general millimeter wave band.

FIG. 8 A diagram for describing a problem of terminal positioning by a communication signal itself.

### DESCRIPTION OF EMBODIMENTS

Hereinafter, an embodiment of the present invention will be described with reference to the drawings.

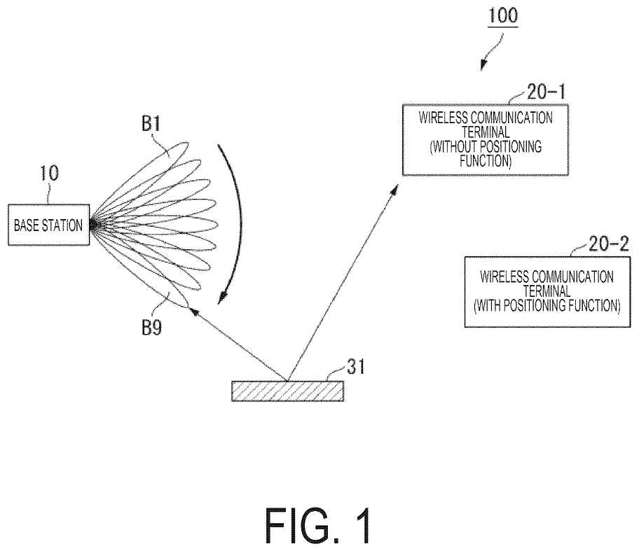

FIG. 1 is a diagram illustrating a configuration example of a wireless communication system 100 in an embodiment. The wireless communication system 100 includes a base station 10 and a plurality of wireless communication terminals 20. Although two wireless communication terminals 20-1 and 20-2 are illustrated in FIG. 1, the wireless communication system 100 may include three or more wireless communication terminals 20.

The base station 10 communicates with the wireless communication terminals 20-1 and 20-2. For example, the base station 10 sequentially forms a plurality of candidate beams in different directions and transmits a signal for each candidate beam. The candidate beam is a beam having directivity in a specific direction. In FIG. 1, nine candidate beams B1 to B9 are illustrated as candidate beams formed by the base station 10. For example, the base station 10 sequentially forms the candidate beams B1 to B9 and transmits a signal for each candidate beam. The candidate beams B1 to B9 have different directivity directions. Note that the number of candidate beams formed by the base station 10 is not particularly limited. As illustrated in FIG. 1, when the base station 10 forms a candidate beam B9 and transmits a signal, the transmitted signal is reflected by the object 31 and reaches the wireless communication terminal 20-1.

The base station 10 receives a response to the signal transmitted using the formed candidate beam from the wireless communication terminal 20. The base station 10 acquires quality information of each candidate beam on the basis of the received response. The base station 10 estimates the position of the wireless communication terminal 20 on the basis of the acquired quality information of each candidate beam. The quality information is information related to candidate beams, and may be, for example, a received signal strength indication (RSSI) of a signal (for example, a response) transmitted from the wireless communication terminal 20 obtained when the base station 10 uses the candidate beams, a signal-to-noise power ratio (SNR) obtained by estimating noise, any of information for specifying which candidate beam is used such as an ID of a candidate beam actually used for communication, information of a transmission distance acquired by a distance estimation function (for example, RTT), or any combination thereof.

The wireless communication terminal 20-1 communicates with the base station 10. The wireless communication terminal 20-1 is a communication device that does not have a positioning function. The positioning function is a function for measuring the position of the wireless communication terminal 20. The positioning function is, for example, a function of measuring a position using a GNSS such as GPS or GLONASS when outdoors, and a function of measuring a position using a method such as BLE or UWB when indoors, but any method may be used. The wireless communication terminal 20-1 receives a signal transmitted from the base station 10 and transmits a response to the received signal to the base station 10. The response may be, for example, a signal indicating that a signal transmitted from the base station 10 has been received.

The wireless communication terminal 20-2 communicates with the base station 10. The wireless communication terminal 20-2 is a communication device having the positioning function. The wireless communication terminal 20-2 receives a signal transmitted from the base station 10 and transmits a response to the received signal to the base station 10. Furthermore, the wireless communication terminal 20-2 transmits position information measured by the positioning function to the base station 10 in response to a request from the base station 10.

Note that, depending on the positional relationship between the base station 10 and the wireless communication terminals 20-1 and 20-2, the wireless communication terminals 20-1 and 20-2 may not be able to receive all the signals transmitted by the base station 10 using the candidate beams. Thus, the wireless communication terminals 20-1 and 20-2 are only required to transmit responses to the received signals to the base station 10.

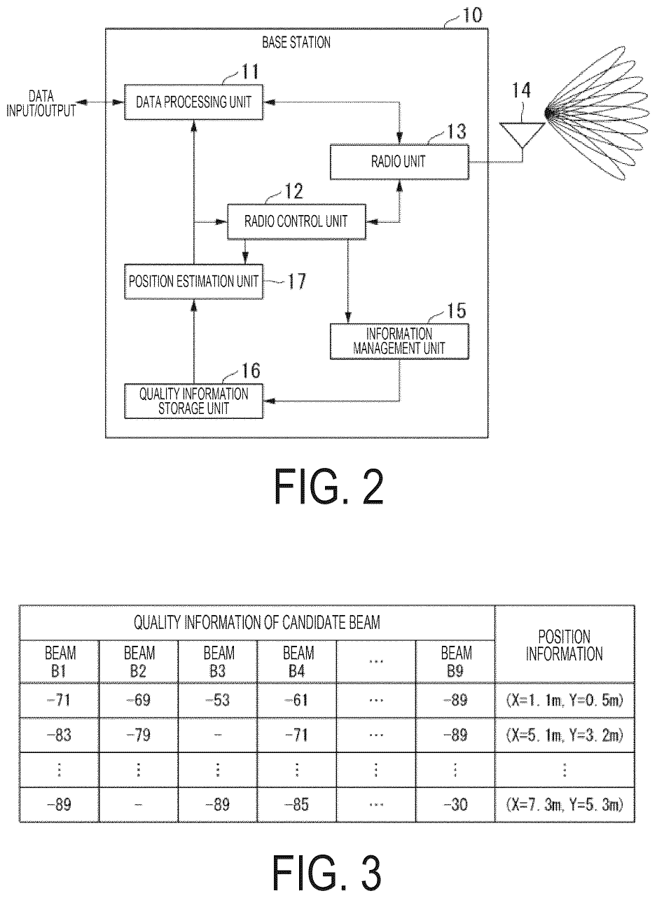

FIG. 2 is a diagram illustrating a functional configuration example of the base station 10 in the embodiment. The base station 10 includes a data processing unit 11, a radio control unit 12, a radio unit 13, an antenna 14, an information management unit 15, a quality information storage unit 16, and a position estimation unit 17.

The data processing unit 11 inputs and outputs data to and from a higher-level device located above the base station 10 or another base station. For example, the data processing unit 11 outputs position information of the wireless communication terminal 20 estimated by the position estimation unit 17 to a higher-level device or another base station located at a higher level than the base station 10.

The radio control unit 12 controls the radio unit 13. For example, the radio control unit 12 instructs the radio unit 13 to sequentially switch a plurality of candidate beams and transmit a signal for each candidate beam. The radio control unit 12 acquires the quality information for each candidate beam on the basis of the response for each candidate beam received by the radio unit 13. Further, when position information is received by the radio unit 13, the radio control unit 12 acquires the received position information.

In accordance with an instruction from the radio control unit 12, the radio unit 13 controls an amplitude or a phase of the antenna 14 to form a plurality of candidate beams in different directions, and sequentially switches the plurality of candidate beams to transmit a signal. The radio unit 13 receives a signal (for example, a response) transmitted from the wireless communication terminal 20 via the antenna 14.

The antenna 14 forms a plurality of candidate beams in different directions under the control of the radio unit 13. The antenna 14 transmits a signal by radiating a radio wave using the formed candidate beam. The antenna 14 receives a radio wave transmitted from the wireless communication terminal 20 using the formed candidate beam.

The information management unit 15 registers the quality information of each candidate beam acquired by the radio control unit 12 and position information in the quality information storage unit 16 in association with each other. For example, when both the quality information of each candidate beam and position information are obtained from the radio control unit 12, the information management unit 15 registers the obtained quality information of each candidate beam and the position information in the quality information storage unit 16 in association with each other.

The quality information storage unit 16 stores a quality information table. The quality information table is a table in which information related to quality information is registered. In the quality information table, position information is associated with quality information of each candidate beam.

The position estimation unit 17 refers to the quality information table and estimates the position of the wireless communication terminal 20 on the basis of the quality information of each candidate beam acquired by the radio control unit 12. For example, the position estimation unit 17 estimates the position of the wireless communication terminal 20-1 that does not have the positioning function.

FIG. 3 is a diagram illustrating an example of a quality information table in the embodiment. As illustrated in FIG. 3, the quality information table includes a plurality of records in which information regarding the quality information of each candidate beam is registered. Each record has respective values of the quality information and the position information of each candidate beam. The quality information of each candidate beam registered in each record indicates the quality information acquired by the radio control unit 12 on the basis of the response received by the radio unit 13. In FIG. 3, a value of the received signal strength indicator is registered as an example of the quality information. The position information registered in each record indicates position information acquired in advance by the wireless communication terminal 20 having the positioning function.

Note that the position information may be acquired, for example, by moving an autonomous traveling robot to a designated position using the wireless communication terminal 20 mounted on the autonomous traveling robot in advance, or in the case of the wireless communication terminal 20-2 having the positioning function such as a smartphone, the position information may be acquired using the positioning function. In FIG. 3, the position information is illustrated as a two-dimensional value, but the position information may be three-dimensional. Furthermore, the quality information table may include information on the direction of the antenna included in the wireless communication terminal 20.

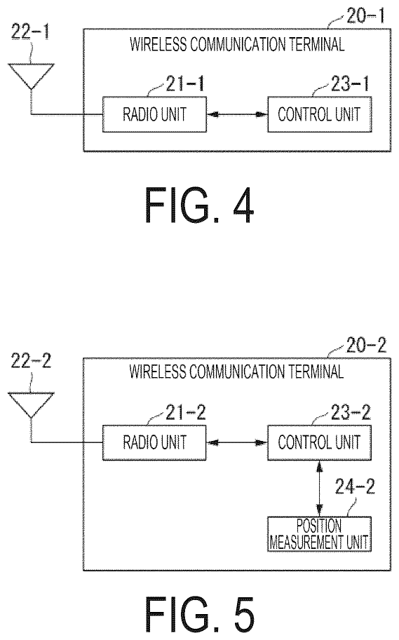

FIG. 4 is a diagram illustrating a configuration example of the wireless communication terminal 20-1 (without the positioning function) in the embodiment. The wireless communication terminal 20-1 includes a radio unit 21-1, an antenna 22-1, and a control unit 23-1.

The radio unit 21-1 transmits a signal via the antenna 22-1 in accordance with an instruction from the control unit 23-1. For example, the radio unit 21-1 transmits a response to a signal transmitted from the base station 10 to the base station 10.

The antenna 22-1 transmits and receives radio waves. The antenna 22-1 converts a received radio wave into an electric signal and outputs the electric signal to the radio unit 21-1. The antenna 22-1 radiates a signal output from the radio unit 21-1 as a radio wave.

The control unit 23-1 controls operation of the wireless communication terminal 20-1. For example, the control unit 23-1 controls the radio unit 21-1 to transmit a response to the received signal.

FIG. 5 is a diagram illustrating a configuration example of the wireless communication terminal 20-2 (with the positioning function) in the embodiment. The wireless communication terminal 20-2 includes a radio unit 21-2, an antenna 22-2, a control unit 23-2, and a position measurement unit 24-2.

The radio unit 21-2 transmits a signal via the antenna 22-2 in accordance with an instruction from the control unit 23-2. For example, the radio unit 21-2 transmits a response to a signal transmitted from the base station 10 to the base station 10. Furthermore, the radio unit 21-2 transmits the position information measured by the position measurement unit 24-2 to the base station 10 in addition to the response to the signal transmitted from the base station 10.

The antenna 22-2 transmits and receives radio waves. The antenna 22-2 converts a received radio wave into an electric signal and outputs the electric signal to the radio unit 21-2. The antenna 22-2 radiates a signal output from the radio unit 21-2 as a radio wave.

The control unit 23-2 controls operation of the wireless communication terminal 20-2. For example, the control unit 23-2 controls the radio unit 21-2 to transmit a response to the received signal. The control unit 23-2 causes the position measurement unit 24 to measure the position information in accordance with an instruction from the base station 10.

The position measurement unit 24-2 measures a position of the wireless communication terminal 20-2 in accordance with an instruction from the control unit 23-2.

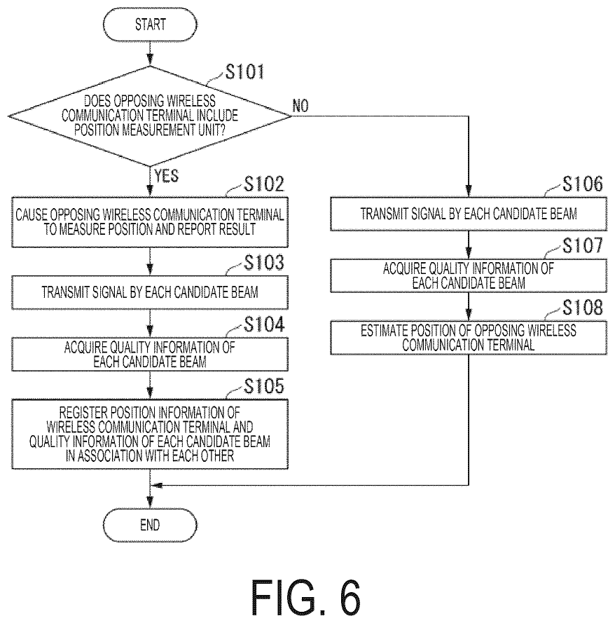

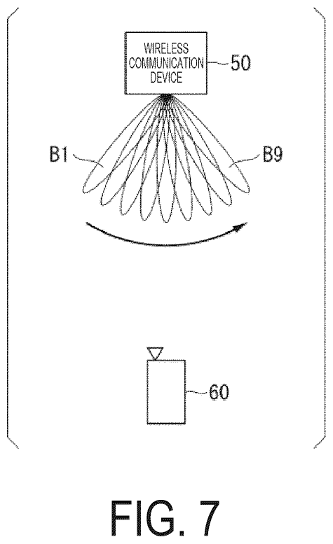

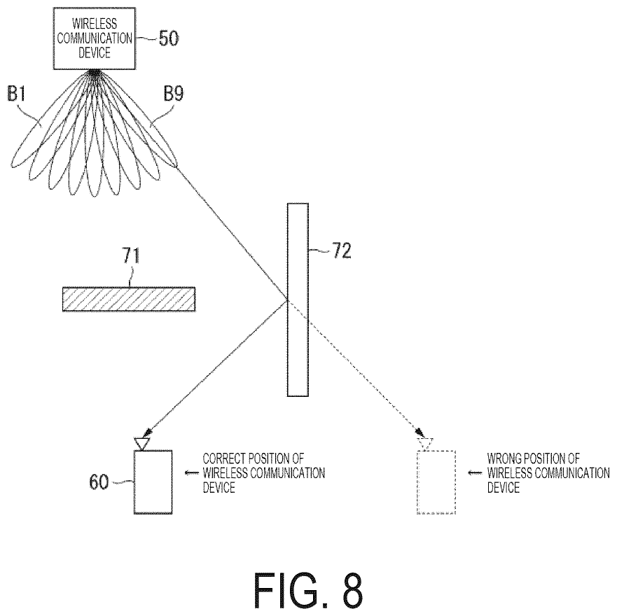

FIG. 6 is a flowchart illustrating a flow of position estimation processing performed by the base station 10 in the embodiment.

The radio control unit 12 determines whether or not the opposing wireless communication terminal 20 includes the position measurement unit 24 (step S101). As an example, the determination as to whether or not the opposing wireless communication terminal 20 includes the position measurement unit 24 may be performed on the basis of a connection request signal transmitted when the wireless communication terminal 20 is connected to the base station 10.

Specifically, the wireless communication terminal 20 includes information indicating whether or not the wireless communication terminal 20 includes the position measurement unit 24 in a connection request signal transmitted when connecting to the base station 10, and transmits the connection request signal to the base station 10. The radio control unit 12 of the base station 10 determines that the opposing wireless communication terminal 20 includes the position measurement unit 24 when the connection request signal transmitted from the opposing wireless communication terminal 20 includes information indicating that the wireless communication terminal 20 includes the position measurement unit 24, and determines that the opposing wireless communication terminal 20 does not include the position measurement unit 24 when the connection request signal includes information indicating that the wireless communication terminal 20 does not include the position measurement unit 24. Note that this determination method is an example, and it may be determined whether or not the opposing wireless communication terminal 20 includes the position measurement unit 24 by another method.

If it is determined that the opposing wireless communication terminal 20 includes the position measurement unit 24 (YES in step S101), the radio control unit 12 causes the wireless communication terminal 20 (for example, the wireless communication terminal 20-2) including the position measurement unit 24 to measure the position and report the result (step S102).

Specifically, the radio control unit 12 controls the radio unit 13 to transmit a signal including an instruction to measure the position. The radio unit 13 transmits the signal including the instruction to measure the position to the wireless communication terminal 20 (for example, the wireless communication terminal 20-2) including the position measurement unit 24 via the antenna 14 according to the control of the radio control unit 12.

The position measurement unit 24-2 of the wireless communication terminal 20-2 measures the position according to the instruction included in the signal transmitted from the base station 10. The wireless communication terminal 20-2 transmits a signal including measured position information to the base station 10 via the antenna 22-2. Thus, the base station 10 acquires the position information of the wireless communication terminal 20-2. Next, the radio control unit 12 of the base station 10 controls the radio unit 13 to transmit a signal by each candidate beam. The radio unit 13 controls at least one of the amplitude or the phase of the antenna 14 according to the control of the radio control unit 12, and transmits the signal by each candidate beam while sequentially changing the candidate beam (step S103). Thus, the wireless communication terminal 20-2 receives the signal of each candidate beam. The wireless communication terminal 20-2 transmits a response to the received signal of each candidate beam to the base station 10. Note that the wireless communication terminal 20-2 transmits the response to the received signal to the base station 10 every time the signal of the candidate beam is received. candidate beam. The radio unit 13 outputs the received response to the radio control unit 12. Every time the response is received, the radio unit 13 outputs the received response to the radio control unit 12. The radio control unit 12 acquires quality information for each response output from the radio unit 13 (step S104). The radio control unit 12 outputs the position information acquired in the processing of step S102 and the quality information of each candidate beam acquired in the processing of step S104 to the information management unit 15. The information management unit 15 registers the position information output from the radio control unit 12 and the quality information of each candidate beam in the quality information table in association with each other (step S105).

If it is determined in the processing of step S101 that the opposing wireless communication terminal 20 does not include the position measurement unit 24 (step S101: NO), the radio control unit 12 controls the radio unit 13 to transmit a signal by each candidate beam. The radio unit 13 controls at least one of the amplitude or the phase of the antenna 14 according to the control of the radio control unit 12, and transmits the signal by each candidate beam while sequentially changing the candidate beam (step S106). Thus, the wireless communication terminal 20-1 receives the signal of each candidate beam. The wireless communication terminal 20-1 transmits a response to the received signal of each candidate beam to the base station 10. Note that the wireless communication terminal 20-1 transmits the response to the received signal to the base station 10 every time the signal of the candidate beam is received.

The radio unit 13 of the base station 10 receives the response to the signal by each candidate beam. The radio unit 13 outputs the received response to the radio control unit 12. Every time the response is received, the radio unit 13 outputs the received response to the radio control unit 12. The radio control unit 12 acquires quality information for each response output from the radio unit 13 (step S107). The radio control unit 12 outputs the acquired quality information of each candidate beam to the position estimation unit 17. The position estimation unit 17 refers to the quality information table stored in the quality information storage unit 16, and estimates the position of the wireless communication terminal 20 (for example, the wireless communication terminal 20-1) not including the position measurement unit 24 on the basis of the quality information of each candidate beam acquired by the radio control unit 12 (step S108).

Specifically, first, the position estimation unit 17 reads the quality information table stored in the quality information storage unit 16. Next, the position estimation unit 17 refers to items of the quality information of the candidate beam in the read quality information table and selects a record having a value closest to the quality information of each candidate beam acquired by the radio control unit 12. A combination of the quality information of the beams B1 to B9 is registered in one record of the quality information table. Thus, the position estimation unit 17 selects the combination of the quality information closest to the combination of the quality information of each candidate beam acquired by the radio control unit 12 from combinations of the quality information of each candidate beam registered in each record of the quality information table.

The quality information and the position information for each candidate beam registered in the quality information table are registered as discrete values. Accordingly, the position estimation unit 17 selects a record having a value closest to the quality information of each candidate beam acquired by the radio control unit 12 by performing regression analysis. As a regression analysis method, for example, linear regression may be used, or any method such as a k-nearest neighbor algorithm or a random forest method may be used. The position estimation unit 17 estimates position information associated with the combination of the quality information in the selected record as the position of the wireless communication terminal 20-1 not including the position measurement unit 24.

According to the wireless communication system 100 configured as described above, it is possible to more accurately estimate the position of the wireless communication device using the signal used for communication. Specifically, in the wireless communication system 100, the base station 10 includes the radio unit 13 that forms a plurality of candidate beams in different directions and transmits a signal for each of the candidate beams, and receives a response to a signal received by the wireless communication terminal 20, the radio control unit 12 that acquires quality information regarding the candidate beams for each of the candidate beams on the basis of the response received by the radio unit 13, and the position estimation unit 17 that refers to the quality information table and estimates the position of the wireless communication terminal 20 on the basis of the quality information of each of the candidate beams acquired by the radio control unit 12.

Thus, even when the opposing wireless communication terminal 20 does not include the position measurement unit 24, it is possible to estimate the position of the opposing wireless communication terminal 20 by referring to the quality information of each candidate beam used by the base station 10. Therefore, even in the case of performing communication using a reflection path, the position of the opposing wireless communication terminal 20 can be estimated using the communication signal itself without providing the wireless communication terminal 20 with the positioning function. Thus, it is possible to more accurately estimate the position of the wireless communication device using a signal used for communication.

In the wireless communication system 100, when the position information of the opposing wireless communication terminal 20 can be acquired, the acquired position information of the wireless communication terminal 20 and the quality information of the candidate beam used by the base station 10 are associated with each other and registered in the quality information table. Thus, it is possible to estimate the position of the opposing wireless communication terminal 20 by referring to the quality information of each candidate beam used by the base station 10.

Hereinafter, a modification of the wireless communication system 100 will be described.

### Modification 1

In the above-described embodiment, the wireless communication system 100 includes the wireless communication terminal 20-1 not having the positioning function and the wireless communication terminal 20-2 having the positioning function, but the wireless communication system 100 may include only the wireless communication terminal 20 not having the positioning function. For example, when correspondence information between target position information and the quality information is registered in the quality information table, it is not necessary to newly register position information in the wireless communication system 100. Thus, when the correspondence information between the target position information and the quality information is registered in the quality information table, the wireless communication system 100 may include only the wireless communication terminal 20 that does not have the positioning function.

### MODIFICATION 2

In the above-described embodiment, the configuration has been described in which the position estimation unit 17 estimates the position of the wireless communication terminal 20 on the basis of one piece of the quality information. The position estimation unit 17 may be configured to estimate the position of the wireless communication terminal 20 on the basis of a combination of a plurality of pieces of quality information. For example, the position estimation unit 17 may estimate the position of the wireless communication terminal 20 on the basis of a combination of a received signal strength indicator and a signal-to-noise power ratio, or may use another combination. In a case where the position of the wireless communication terminal 20 is estimated on the basis of a combination of the received signal strength indicator and the signal-to-noise power ratio, values of the received signal strength indicator and the signal-to-noise power ratio are registered in the quality information table for each candidate beam at least as quality information of each candidate beam. Furthermore, the radio control unit 12 acquires the received signal strength indicator and the signal-to-noise power ratio for each candidate beam on the basis of the response obtained from the wireless communication terminal 20. Then, the position estimation unit 17 refers to the quality information table and estimates the position of the wireless communication terminal 20 on the basis of the quality information (the received signal strength indicator and the signal-to-noise power ratio) of each candidate beam acquired by the radio control unit 12.

### Modification 3

In the above-described embodiment, the configuration in which the base station 10 estimates the position of the wireless communication terminal 20 has been described. On the other hand, in a case where the wireless communication terminal 20 has a configuration in which a plurality of candidate beams is sequentially formed in different directions and a signal is transmitted for each candidate beam, the wireless communication terminal 20 may be configured to estimate the position of the base station 10 by a method similar to that of the base station 10. In such a configuration, the wireless communication terminal 20 implements a configuration in which a plurality of candidate beams is sequentially formed in different directions in the radio unit 21, the antenna 22, and the control unit 23 and a signal is transmitted for each candidate beam, and further includes the information management unit 15, the quality information storage unit 16, and the position estimation unit 17. The base station 10 receives the signal transmitted from the wireless communication terminal 20 and transmits a response to the received signal to the wireless communication terminal 20.

### Correspondence With Claims

The base station 10 is an aspect of a first communication device, a second communication device, and a wireless communication device. The wireless communication terminal 20 is an aspect of a first communication device, a second communication device, and a wireless communication device. When the base station 10 is the first communication device, the wireless communication terminal 20 is the second communication device, and when the base station 10 is the second communication device, the wireless communication terminal 20 is the first communication device.

Some or all of the functional units of the base station 10 and the wireless communication terminal 20 in the above-described embodiments are implemented as software by one or more processors such as a central processing unit (CPU) executing a program stored in a storage device including a nonvolatile recording medium (non-transitory recording medium) and a memory. The program may be recorded in a computer-readable non-transitory recording medium. The computer-readable non-transitory recording medium is, for example, a portable medium such as a flexible disk, a magneto-optical disk, a read only memory (ROM), or a compact disc-ROM (CD-ROM), or a non-transitory recording medium such as a storage device such as a hard disk built in a computer system.

Some or all of the functional units of the base station 10 and the wireless communication terminal 20 may be implemented by using, for example, hardware including an electronic circuit (or circuitry) by using a large scale integrated circuit (LSI), an application specific integrated circuit (ASIC), a programmable logic device (PLD), a field programmable gate array (FPGA), or the like. reference to the drawings, specific configurations are not limited to the embodiments, and include design and the like within the scope of the present invention without departing from the gist of the present invention.

### INDUSTRIAL APPLICABILITY

The present invention can be applied to a technique for estimating a position of a wireless communication device that does not have a positioning function.

### REFERENCE SIGNS LIST

10 Base station
20, 20-1, 20-2 Wireless communication terminal
11 Data processing unit
12 Radio control unit
13 Radio unit
14, 22-1, 22-2 Antenna
15 Information management unit
16 Quality information storage unit
17 Position estimation unit
21-1, 21-2 Radio unit
23-1, 23-2 Control unit
24 Position measurement unit

1. A wireless communication system comprising a first communication device and one or more second communication devices that communicate with the first communication device, wherein
the first communication device includes:
a radio unit configured to form a plurality of candidate beams in different directions and transmits a signal for each of the candidate beams, and receives a response to a signal received by the one or more second communication devices;
a radio controller configured to acquire quality information regarding the candidate beams for each of the candidate beams on a basis of the response received by the radio unit; and
a position estimator configured to refer to correspondence information in which the quality information of each of the candidate beams and position information are associated with each other, and estimates a position of the one or more second communication devices on a basis of the quality information of each of the candidate beams acquired by the radio controller, and
the one or more second communication devices
transmit a response to a signal transmitted from the first communication device.

2. The wireless communication system according to claim 1, wherein
in a case where there is a second communication device that does not include a positioner configured to measure a position among the one or more second communication devices, the radio unit of the first communication device receives the response for each of the candidate beams from the second communication device that does not include the positioner, and
the position estimator refers to the correspondence information and estimates position information associated with quality information closest to the quality information of each of the candidate beams obtained on a basis of the response received by the radio unit as a position of the second communication device that does not include the positioner.

3. The wireless communication system according to claim 2, wherein
the position estimator determines the quality information closest to the quality information of each of the candidate beams acquired by the radio controller by performing regression analysis.

4. The wireless communication system according to claim 1, further comprising:
an information manager configured to manage the correspondence information, wherein
in a case where there is a second communication device including a positioner that measures a position among the one or more second communication devices, the radio unit of the first communication device receives position information in addition to the response for each of the candidate beams from the second communication device including the positioner, and
the information manager registers the quality information of each of the candidate beams obtained on a basis of the response received from the second communication device including the positioner and the position information in the correspondence information in association with each other.

5. A position estimation method performed by a wireless communication system including a first communication device and one or more second communication devices that communicate with the first communication device, the position estimation method comprising:
by the first communication device,
forming a plurality of candidate beams in different directions and transmitting a signal for each of the candidate beams,
receiving a response to a signal received by the one or more second communication devices,
acquiring quality information regarding the candidate beams for each of the candidate beams on a basis of the received response, and
referring to correspondence information in which the quality information of each of the candidate beams and position information are associated with each other, and estimating a position of the one or more second communication devices on a basis of the quality information of each of the acquired candidate beams; and
by the one or more second communication devices,
transmitting a response to a signal transmitted from the first communication device.

6. A wireless communication device comprising:
a radio unit configured to form a plurality of candidate beams in different directions and transmits a signal for each of the candidate beams, and receives a response to a signal received by an opposing device;
a radio controller configured to acquire quality information regarding the candidate beams for each of the candidate beams on a basis of the response received by the radio unit; and
a position estimator configured to refer to correspondence information in which the quality information of each of the candidate beams and position information are associated with each other, and estimates a position of the opposing device on a basis of the quality information of each of the candidate beams acquired by the radio controller.
